(19) United States
(12) Patent Application Publication
(10) Pub. No.: US 2006/0108330 A1
(43) Pub. Date: May 25, 2006

(54) Apparatus for dry-surface cleaning using a laser

(75) Inventors: Jong-Myoung Lee, Anyang-si (KR); Taehoon Kim, Yongin-si (KR)

Correspondence Address: MAYER, BROWN, ROWE & MAW LLP, 1909 K STREET, N.W., WASHINGTON, DC, 20006, US

(73) Assignee: IMT CO., LTD.

(21) Appl. No.: 11/194,445

(22) Filed: Aug. 2, 2005

(30) Foreign Application Priority Data
Nov. 24, 2004 (KR) 10-2004-0096823

(51) Int. Cl. B23K 26/00

(52) U.S. Cl. 219/121.6

(57) ABSTRACT

A dry-surface cleaning apparatus includes a laser for generating laser beams, a focus lens for generating a plasma shock wave around a laser focus by converging the laser beams into the laser focus around a workpiece to be cleaned, wherein contaminants on the workpiece are removed by colliding the plasma shock wave against the workpiece, and a thermal radiation protector for avoiding a surface damage on the workpiece induced by a plasma thermal radiation entailed by the generation of the plasma shock wave. The thermal radiation protector is installed between the laser focus and the workpiece and is extended toward a downstream of the laser focus to a position where a portion of remaining laser beam when generating the plasma shock wave reaches in order to reflect the remaining laser beam.

### FIELD OF THE INVENTION

The present invention relates to a dry-surface cleaning apparatus for removing contaminants on a workpiece using a laser; and, more particularly, to a dry-surface cleaning apparatus capable of blocking a surface damage on a workpiece from a plasma thermal radiation entailed by a laser induced shock wave.

### BACKGROUND OF THE INVENTION

U.S. Pat. No. 5,023,424, entitled “Shock wave particle removal method and apparatus” discloses a technique for removing contaminants on a workpiece to be cleaned by generating a plasma shock wave using a laser and then colliding the generated plasma shock wave against the workpiece to be cleaned, wherein the plasma shock wave propagates from a laser focus in all directions by concentrating in the air a high-energy laser beam (0.1˜10 J/pulse) of a short pulse wave (below 1˜100 nanosecond) irradiated from a laser, which is incorporated herein by reference.

Further, U.S. Pat. No. 6,635,845, entitled “Dry-surface cleaning apparatus using a laser” discloses a technique for preventing a surface damage caused by directly irradiating a laser beam onto a workpiece, which has been assigned to the same assigner as is incorporated herein by reference. Referring to U.S. Pat. No. 6,635,845, there is provided a path conversion device for changing a proceeding direction of a remaining laser beam that has not been vanished by way of reflecting the remaining laser beam before it reaches the workpiece, to thereby prevent the remaining laser beam from being irradiated on the workpiece when the surface of the workpiece is cleaned by using a laser induced shock wave. By installing such path conversion device, it is possible to prevent a surface damage caused by directly irradiating a laser beam onto the workpiece.

FIG. 1 shows a schematic view illustrating the generation of a surface damage on a workpiece in a dry-surface cleaning apparatus using a laser of a prior art.

Laser beam 2 of a pulse wave is concentrated by a focus lens 1 in an air around a surface of a workpiece 10. If energy of the laser beam 2 around a laser focus 3 is greater than or equal to a threshold, the air itself around the laser focus 3 becomes ionized, thereby generating powerful plasma 4. Accordingly, a plasma shock wave 5 corresponding to the plasma 4 propagates in all directions, thereby removing contaminants on the surface of the workpiece 10. However, all of the energy of the laser beams 2 are not used for generating the plasma shock wave 5 and, therefore, a portion of the laser beam propagates along the proceeding direction of the laser beam 2 toward the surface of the workpiece 10. The laser beam 2 propagated on the surface of the workpiece 10 is converted into a thermal energy, so that a surface damage 11 on the workpiece is inflicted. However, such surface damage 11 can be effectively prevented by the path conversion device described in the aforementioned 845' Patent.

Meanwhile, the plasma 4 generated from the laser focus 3 serves as a heating source radiating a high-temperature heat, wherein the heat radiated from such heating source is referred to as a plasma thermal radiation 6. The plasma thermal radiation 6 continuously proceeds after passing the laser focus 3 and then is projected onto the surface of the workpiece 10, which causes a surface damage of the workpiece 10.

However, none of dry-surface cleaning apparatuses is provided with a measurement capable of blocking the irradiation of the plasma thermal radiation. Thus, it is impossible to prevent the plasma thermal radiation 6 from causing the surface damage 12 on the workpiece 10.

Especially, materials sensitive to heat or light such as semiconductor devices, magnetic devices, organic materials, thin film coating layers and the like may be seriously damaged on the surface thereof by the plasma thermal radiation 6.

### SUMMARY OF THE INVENTION

It is, therefore, an object of the present invention to provide a dry-surface cleaning apparatus using a laser, which is capable of preventing a surface damage caused by directly irradiating a plasma thermal radiation onto a workpiece to be cleaned.

In accordance with the present invention, there is provided a dry-surface cleaning apparatus for removing contaminants on a workpiece surface, including: a laser for generating laser beams; a focus lens for generating a plasma shock wave around a laser focus by converging the laser beams into the laser focus around the workpiece surface, wherein contaminants on the workpiece surface are removed by colliding the plasma shock wave against the workpiece surface; and a thermal radiation protection device for reflecting or absorbing a plasma thermal radiation generated when the plasma shock wave is generated, the thermal radiation protection device being installed at a position where a plasma thermal radiation is generated, i.e., between the laser focus and the workpiece surface.

### Brief Description of the Drawings

The above and other objects and features of the present invention will become apparent from the following description of preferred embodiments, given in conjunction with the accompanying drawings, in which:

FIG. 1 shows a schematic view illustrating the generation of a surface damage on a workpiece in a dry-surface cleaning apparatus using a laser in accordance with a prior art;

FIG. 2 describes a schematic view of a dry-surface cleaning apparatus provided with a thermal radiation protection device in accordance with the present invention;

FIG. 3 provides a schematic view of another example of the thermal radiation protector shown in FIG. 2; and

FIGS. 4A and 4B represent schematic views of modified examples of the thermal radiation protection device shown in FIG. 3.

### DETAILED DESCRIPTION OF THE PREFERRED EMBODIMENT

Hereinafter, preferred embodiments of the dry-surface cleaning apparatus in accordance with the present invention will be described in detail with reference to the accompanying drawings, in which like reference numerals indicates like elements.

FIG. 2 describes a schematic view of a dry-surface cleaning apparatus using a laser in accordance with the present invention.

The dry-surface cleaning apparatus of the present invention includes a focus lens 1, a thermal radiation protector 21 and a laser beam absorber 23.

The focus lens 1 is used for converging the laser beam 2 produced from a laser (not shown) into a laser focus 3 in an air around a surface of a workpiece 10 to be cleaned. If energy of the laser beams 2 is greater than or equal to a threshold around the laser focus 3, the air itself around the laser focus 3 becomes ionized, thereby generating powerful plasma 4. Accordingly, a plasma shock wave 5 corresponding to the plasma 4 propagates to the workpiece 10, thereby removing contaminants on the surface of the workpiece 10 beneath of the laser focus 3.

Meanwhile, when the plasma shock wave 5 is generated, a plasma thermal radiation 6 is inevitably generated. The plasma thermal radiation 6 radiates toward a downstream of the laser focus 3 along a proceeding path of the remaining laser beam 2a without radiating toward an upstream of the laser focus 3. Therefore, the plasma thermal radiation 6 passes the laser focus 3 and then is projected onto the surface of the workpiece 10, which cause the surface damage of the workpiece 10.

In order to prevent the surface damages, the thermal radiation protector 21 is installed between the laser focus 3 and the surface of the workpiece 10 to which the plasma shock wave 5 is irradiated. The thermal radiation protector 21 serves to effectively reflect or absorb the plasma thermal radiation 6 radiating toward the workpiece 10.

Substantially, the plasma thermal radiation 6 slantingly proceeds toward the downstream of the laser focus 3 along the proceeding path of the remaining laser beam 2a. Therefore, the thermal radiation protector 21 is installed so that one end of the thermal radiation protector 21 (a left side in the drawing) is aligned at a point where the laser focus is formed. In this case, the thermal radiation protector 21 may block a certain amount of the plasma shock wave 5 propagating toward the surface of the workpiece 10. However, the surface cleaning of the workpiece 10 can be sufficiently carried out only by the amount of the unblocked plasma shock waves 5.

Further, it is preferable that the thermal radiation protector 21 is selected from an opaque or a transparent solid material capable of entirely reflecting or absorbing the plasma thermal radiation 6.

In case the transparent solid material is used for the thermal radiation protector 21, it is possible to considerably reduce the amount of plasma thermal radiation 6 reaching the workpiece 10. Instead, a very small amount of the plasma thermal radiation 6 passes through the transparent solid material and then reaches the workpiece 10, which is undesirable. Particularly, in case the workpiece 10 is made of a sensitive material, e.g., a semiconductor wafer, a very small amount of the plasma thermal radiation 6 may inflict a serious damage, which is more undesirable. Therefore, it is preferable to employ the opaque material rather than the transparent material in order to block the plasma thermal radiation.

As for the aforementioned opaque solid material, a chemically stable noble metal such as Au(gold), Ag(silver), Pt(platinum) and Rh(rhodium) is appropriate. Further, a nonmetal, e.g., Si(silicon), especially, single crystalline silicon, may also be appropriately used. Such materials, which have been discovered by a variety of experiments, have good reflectivity against the plasma thermal radiation 6 and the laser beam 2 and, therefore, the surface of the workpiece is free from damage. Moreover, such materials have good corrosion resistance, durability or the like and thus are hardly damaged or transformed by the plasma shock wave 5.

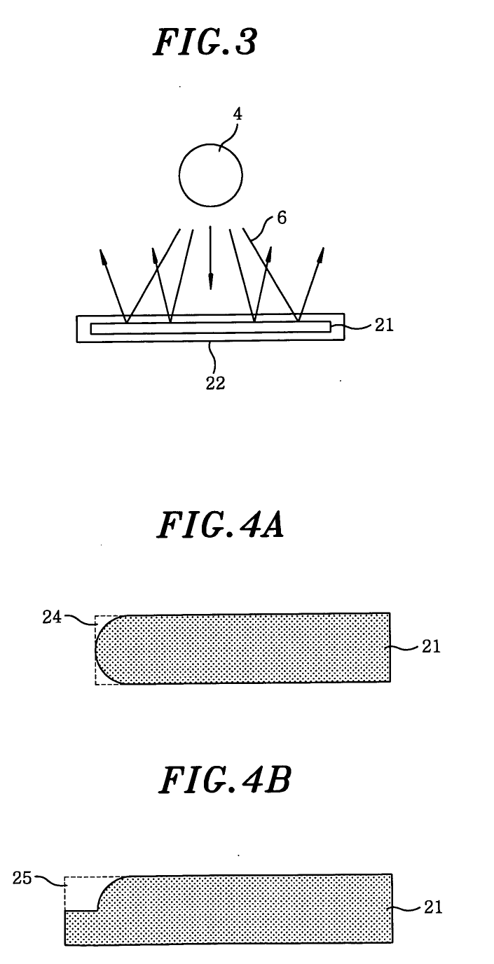

Further, it is preferable that the opaque solid material has a high purity whether it is a metal or a nonmetal. This is because if impurities are contained in the corresponding material, a portion of the remaining laser beam 2a may inflict damage on the surface of the workpiece 10 when the plasma shock wave 5 is generated. Furthermore, the thermal radiation protector 21 is manufactured in a form of a thin sheet enough to block the plasma thermal radiation 6. However, if the thickness of the thin sheet is too thin, it is difficult to maintain its original shape, thereby easily being bent by the plasma shock waves 5. To overcome the above shortcoming, the thin sheet of the protector 21 is entirely enclosed by a plate 22 of a transparent material so that the shape of the thin sheet can be maintained as shown in FIG. 3. In this case, it is preferable to employ a quartz plate or a glass plate for the transparent plate 22.

Moreover, the thermal radiation protector 21 has a length extending to a point where the remaining laser beam 2a reaches the surface of the workpiece 10. With such a configuration, a portion of the remaining laser beam 2a that continuously proceeds toward the downstream of the laser focus 3 without having been vanished during the generation of the plasma shock wave 5 is totally reflected on the surface of the protector 21. Thus, a direction of the remaining laser beam 2a is changed, so that it is possible to prevent a surface damage of the workpiece 10 from the remaining laser beam 2a.

Further, at a rear side of the thermal radiation protector 21, a laser beam absorber 23 is optionally installed to absorb and remove the remaining laser beam 2a that has been totally reflected by the thermal radiation protector 21. As a result, it is possible to effectively inhibit a reaction between the totally reflected remaining laser beam 2a and an outside material.

FIGS. 4A and 4B present modified examples of the thermal radiation protector in accordance with the present invention.

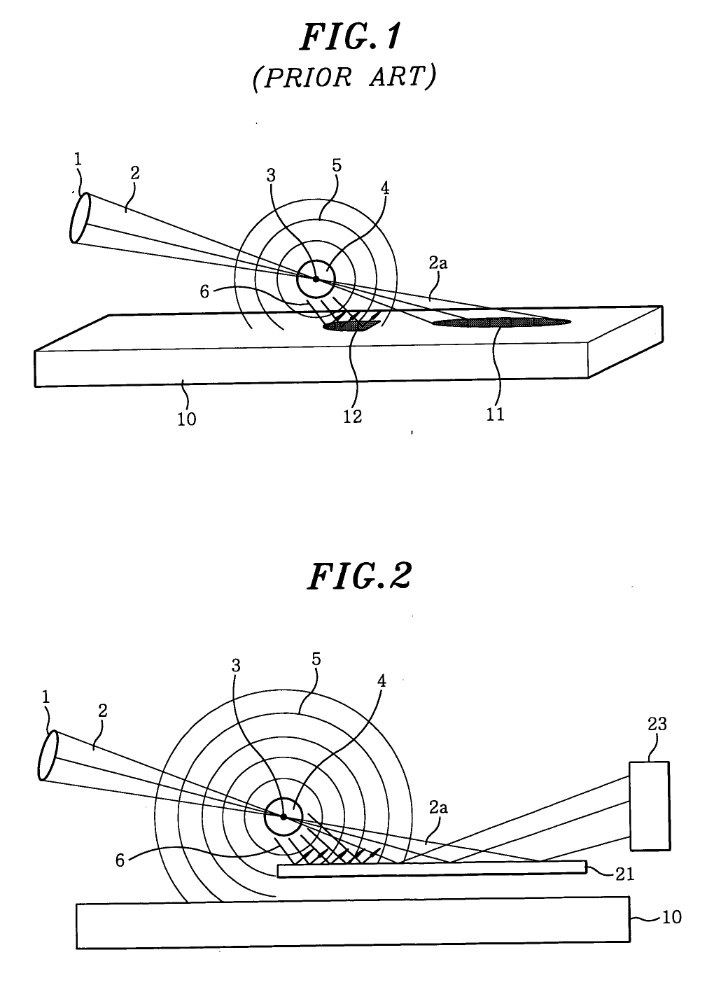

As illustrated in FIG. 1, the plasma thermal radiation 6 has a semicircular shape when it is irradiated on the workpiece 10 to thereby leave a trace of a semicircular shape. Thus, according to the present invention, the thermal radiation protector 21 is designed to have the same shape as illustrated in FIG. 4a wherein one end thereof to which the plasma thermal radiation reaches is rounded in a semicircular shape or removed in a bracket shape 24. By the thermal radiation protector 21 having the removed portion 24 to leave the rounded end portion, the irradiation of the plasma thermal radiation 6 is blocked while the more amount of the plasma shock wave 5 can be applied through the removed portion 24, thereby increasing a cleaning efficiency for the workpiece 10.

Moreover, referring to FIG. 4B, there is illustrated a configuration in which a half of one end of the thermal radiation protector 21 is partially rounded or removed in a trapezoid shape 25 and a remaining half part of the end portion is protrudently extended. With such configuration, a symmetrical movement of the plasma shock wave 5 is blocked by the extended portion and the plasma shock wave 5 proceeds only at the removed portion of the trapezoid shape 25. Thus, the plasma wave 5 has directionality when removing contaminants.

According to the present invention described above, the surface of the workpiece 10 is free from the effects of the plasma thermal radiation 6, thereby generating no surface damage by the plasma thermal radiation 6.

While the invention has been shown and described with respect to the preferred embodiments, it will be understood by those skilled in the art that various changes and modification may be made without departing from the spirit and scope of the invention as defined in the following claims.

What is claimed is:

1. A dry-surface cleaning apparatus, comprising:
a laser for generating laser beams;
a focus lens for generating a plasma shock wave around a laser focus by converging the laser beams into the laser focus around a workpiece to be cleaned, wherein contaminants on the workpiece are removed by colliding the plasma shock wave against the workpiece; and
thermal radiation protection means for avoiding a surface damage on the workpiece induced by a plasma thermal radiation caused by the generation of the plasma shock wave, the thermal radiation protection device being installed between the laser focus and the workpiece.

2. The apparatus of claim 1, wherein the thermal radiation protection means is made of an opaque solid material.

3. The apparatus of claim 2, wherein the opaque solid material includes a noble metal.

4. The apparatus of claim 2, wherein the opaque solid material includes a nonmetal.

5. The apparatus of claim 2, wherein the opaque solid material has a shape of thin sheet.

6. The apparatus of claim 1, wherein the thermal radiation protection means further includes a transparent material for enclosing and maintaining the sheet of the opaque solid material.

7. The apparatus of claim 1, wherein the thermal radiation protection means is extended toward a downstream of the laser focus to a position where a portion of remaining laser beam without being vanished when generating the plasma shock wave reaches, to thereby totally reflect the remaining laser beam.

8. The apparatus of claim 7, further comprising a laser beam absorber provided at a rear side of the thermal radiation protection means to absorb the remaining laser beams reflected by the thermal radiation protection means.

9. The apparatus of claim 1, wherein the thermal radiation protection means has a removed portion to leave a rounded portion in its one end to which the plasma thermal radiation reaches.

10. The apparatus of claim 1, wherein the thermal radiation protection means has a removed portion to leave a rounded portion in a half of its one end to which the plasma thermal radiation reaches.

11. The apparatus of claim 3, wherein the noble metal is selected from a group composed of Au(gold), Ag(silver), Pt(platinum) and Rh(rhodium).

12. The apparatus of claim 4, wherein the nonmetal includes Si(silicon).

13. The apparatus of claim 1, wherein the thermal radiation protection means is made of a transparent solid material.
